(19) United States
(12) Patent Application Publication
(10) Pub. No.: US 2008/0192812 A1
(43) Pub. Date: Aug. 14, 2008

(54) WIRELESS COMMUNICATION ADAPTER FOR A PROGRAMMABLE LOGIC CONTROLLER AND PROGRAMMABLE LOGIC CONTROLLER SYSTEM INCLUDING THE SAME

(76) Inventors: Marco Naeve, Milwaukee, WI (US); Sujit R. Das, New Berlin, WI (US); Charles J. Luebke, Sussex, WI (US); George S. Deits, Grafton, WI (US)

Correspondence Address: Eaton Corporation, 1111 Superior Avenue, Cleveland, OH, 44114, US

(21) Appl. No.: 11/673,109

(22) Filed: Feb. 9, 2007

(51) Int. Cl. H04B 1/38

(52) U.S. Cl. 375/222

(57) ABSTRACT

A wireless communication adapter is for a programmable logic controller including a local wired communication port, such as an expansion port. The wireless communication adapter includes a first wireless communication port structured to wirelessly communicate with a plurality of remote wireless sensors and a plurality of remote wireless output devices. A second wired communication port is structured to communicate with the expansion port of the programmable logic controller. A processor cooperates with the first wireless communication port and the second wired communication port. The processor, the first wireless communication port and the second wired communication port are structured to communicate a plurality of inputs from the remote wireless sensors to the expansion port of the programmable logic controller and a plurality of outputs from the expansion port of the programmable logic controller to the remote wireless output devices.

### BACKGROUND OF THE INVENTION

1. Field of the Invention

This invention pertains generally to wireless communication and, more particularly, to wireless communication adapters for programmable logic controllers. The invention also pertains to programmable logic controller systems.

2. Background Information

A programmable logic controller (PLC) typically includes a plurality of analog and digital inputs and at least a number of digital outputs. PLCs are used in a wide variety of applications including, for example and without limitation, control of machinery on factory assembly lines, showroom and window store lighting systems, conveyor belt sequence control, temperature and ventilation control, and refrigerator control systems, among others. A PLC is preferably, but need not be, designed for one or more of extended temperature ranges, dirty or dusty conditions, immunity to electrical noise, and resistance to vibration and impact. PLC programs are normally stored in non-volatile memory, such as, for example and without limitation, battery-backed or read-only memory. A PLC preferably operates in real-time or near real-time, in order to timely produce output results in response to input conditions.

Many PLCs include a serial interface for connection to a personal computer (PC) and/or an expansion port for connection to a number of accessories including, for example and without limitation, an additional number of input/output (I/O) modules, power supplies, and communication modules for connection to different wired communication networks.

Intelligent relays or control relays support relatively simple control, automation and monitoring applications where real-time control is not required. Non-limiting examples of such applications include production lines, lighting, temperature control, machine assembly, and plant construction/facility monitoring. Known intelligent relays or control relays are relatively versatile and easily adapted to a wide variety of applications. Although relatively affordable, the major expense associated with intelligent relays or control relays is manual labor associated with installation of the system. For example, there is a relatively substantial expense associated with wired electrical connections for the various I/O modules and a wired communication network.

Removing or at least reducing the number of wires from these products can significantly reduce installation time, simplify the installation process and reduce cost.

Accordingly, there is room for improvement in programmable logic controller systems.

There is also room for improvement in communications to and from programmable logic controllers.

### SUMMARY OF THE INVENTION

These needs and others are met by embodiments of the invention, which provide a wireless communication adapter for a programmable logic controller. The wireless communication adapter provides wireless connectivity to a number of input and output devices, such as, for example and without limitation, a number of wireless sensors or a number of wireless output devices. This reduces the plurality of wires providing inputs to and outputs from the programmable logic controller.

In accordance with one aspect of the invention, a wireless communication adapter is for a programmable logic controller including a local wired communication port. The wireless communication adapter comprises: a first wireless communication port structured to wirelessly communicate with a number of remote wireless sensors or a number of remote wireless output devices; a second wired communication port structured to communicate with the local wired communication port of the programmable logic controller; and a processor cooperating with the first wireless communication port and the second wired communication port, wherein the processor, the first wireless communication port and the second wired communication port are structured to communicate a number of inputs from the number of remote wireless sensors to the local wired communication port of the programmable logic controller or a number of outputs from the local wired communication port of the programmable logic controller to the number of remote wireless output devices.

As another aspect of the invention, a system comprises: a programmable logic controller comprising a local wired communication port; a number of wireless sensors; a wireless communication adapter comprising: a first wireless communication port structured to wirelessly communicate with the number of wireless sensors, a second wired communication port structured to communicate with the local wired communication port of the programmable logic controller, and a processor cooperating with the first wireless communication port and the second wired communication port, wherein the processor, the first wireless communication port and the second wired communication port are structured to communicate a number of inputs from the number of wireless sensors to the local wired communication port of the programmable logic controller.

The wireless communication adapter may be internal to the programmable logic controller.

As another aspect of the invention, a system comprises: a wirelessly enabled node; a programmable logic controller comprising: a local wired communication port, and a number of wired input devices or wired output devices; a wireless communication adapter comprising: a first wireless communication port structured to wirelessly communicate with the wirelessly enabled node, a second wired communication port structured to communicate with the local wired communication port of the programmable logic controller, and a processor cooperating with the first wireless communication port and the second wired communication port, wherein the programmable logic controller is structured to communicate a number of inputs or outputs from the number of wired input devices or wired output devices to the local wired communication port, and wherein the processor, the second wired communication port and the first wireless communication port are structured to communicate the number of inputs or outputs from the local wired communication port of the programmable logic controller to the wirelessly enabled node.

As another aspect of the invention, a system comprises: a programmable logic controller comprising a local wired communication port; a number of wireless sensors; a number of wireless output devices; a wireless communication adapter comprising: a first wireless communication port structured to wirelessly communicate with the number of wireless sensors, a second wired communication port structured to communicate with the local wired communication port of the programmable logic controller, and a processor cooperating with the first wireless communication port and the second wired communication port, wherein the processor, the first wireless communication port and the second wired communication port are structured to communicate a number of inputs from the number of wireless sensors to the local wired communication port of the programmable logic controller, and wherein the processor, the second wired communication port and the first wireless communication port are further structured to communicate a number of outputs from the local wired communication port of the programmable logic controller to the number of wireless output devices.

The wireless communication adapter may be structured to be a router that cooperates with an external network coordinator.

The wireless communication adapter may be structured to be a network coordinator.

The wireless communication adapter may be structured to be an end device.

The wireless communication adapter may be structured to be configured to be one of: (a) a router that cooperates with an external network coordinator; and (b) a network coordinator.

### BRIEF DESCRIPTION OF THE DRAWINGS

A full understanding of the invention can be gained from the following description of the preferred embodiments when read in conjunction with the accompanying drawings in which:

FIG. 1 is a block diagram of a wireless communication adapter and a programmable logic controller in accordance with an embodiment of the invention.

FIG. 2 is a timing diagram of the operating cycle of the programmable logic controller of FIG. 1.

FIG. 3 is a block diagram of a system including a programmable logic controller, a wireless communication adapter and a number of wireless sensors in accordance with another embodiment of the invention.

FIG. 4 is a block diagram of a system including a programmable logic controller, a wireless communication adapter and a number of wired input devices in accordance with another embodiment of the invention.

FIG. 5 is a block diagram of a system including a programmable logic controller, a wireless communication adapter, a number of wireless sensors, a number of wireless output devices and a wirelessly enabled node in accordance with another embodiment of the invention.

FIG. 6 is a sequence diagram showing signals, events and messages associated with an output state change of the wireless output device of FIG. 5.

FIG. 7 is a sequence diagram showing signals, events and messages associated with an input state change of the wireless sensor of FIG. 5.

FIG. 8 is a block diagram of a system including a number of wireless sensors and a programmable logic controller including an internal wireless communication adapter in accordance with another embodiment of the invention.

FIG. 9 is a block diagram of a system including a first programmable logic controller, a first wireless communication adapter, a second programmable logic controller, a second wireless communication adapter and a number of wired input devices in accordance with another embodiment of the invention.

FIG. 10 is a ladder diagram executed by the programmable logic controller of FIG. 5.

### DESCRIPTION OF THE PREFERRED EMBODIMENTS

As employed herein, the term “number” shall mean one or an integer greater than one (i.e., a plurality).

As employed herein, the term “wireless” shall expressly include, but not be limited by, radio frequency (RF), light or visible light or infrared not using optical fibers, ultrasound, wireless area networks, such as, but not limited to, IEEE 802.11 and all its variants (e.g., without limitation, 802.11a; 802.11b; 802.11g), IEEE 802.15 and all its variants (e.g., without limitation, 802.15.1; 802.15.3, 802.15.4), IEEE 802.16 and all its variants, other wireless communication standards (e.g., without limitation, ZigBee™ Alliance standard), HyperLan, DECT, PWT, pager, PCS, Wi-Fi, Bluetooth™, and cellular.

As employed herein, the term “wireless communication network” means a communication network employing wireless communications, such as, for example and without limitation, a wireless sensor network.

As employed herein, the term “wireless sensor network” means a network comprising spatially distributed autonomous nodes using wireless output devices to control outputs and/or wireless sensors to receive inputs that cooperatively sense, for example, physical or environmental conditions, such as for example and without limitation, light, temperature, sound, vibration, pressure, motion or pollutants, at different locations. Non-limiting examples of wireless sensor networks include a wireless facilities management system or a wireless infrastructure management system employed for environment and/or habitat monitoring, healthcare applications, home automation, commercial lighting control or traffic control. Each node in a wireless sensor network is typically equipped with a radio transceiver or other suitable wireless communication device, a processor (e.g., small microcontroller), and an energy source, such as a battery or a mains-powered energy source.

As employed herein, the term “network coordinator” (NC) means a communicating device, which operates as the central controller in an ad-hoc communication network or a wireless communication network.

As employed herein, the term “network device” (ND) means a communicating device (e.g., without limitation, a portable wireless communicating device; a fob; a camera/sensor device; a wireless camera; a control device; and/or a fixed wireless communicating device, such as, for example, switch sensors, motion sensors or temperature sensors as employed in a wireless sensor network), which participates in a wireless communication network, and which is not a network coordinator.

As employed herein, the term “node” includes a ND, a NC or a processing, logging and/or communicating device (e.g., without limitation, a portable communicating device; a fixed communicating device, such as, for example, switches, motion sensors or temperature sensors as employed in a wireless sensor network), which participates in an ad-hoc communication network or a wireless communication network.

As employed herein, the terms “wireless sensor” or “wireless input device” mean an apparatus structured to input data or information and to output related data or information to a wireless communication network. A wireless sensor may optionally include or be operatively associated with zero or a number of output devices. Non-limiting examples of wireless sensors include sensors structured to sense light, to sense proximity, pressure sensors, switch sensors, pushbutton sensors, motion sensors, temperature sensors, sound sensors, vibration sensors, pollution sensors, current sensors and/or voltage sensors.

As employed herein, the term “wired input device” means a wired sensor or another wired apparatus structured to input data or information and to output related data or information to a wired (i.e., non-wireless) input.

As employed herein, the term “wired communication” means non-wireless communication using a number of conductors, such as, for example and without limitation, a number of wires or a number of optical fibers.

As employed herein, the term “output device” means an apparatus structured to input data, information or a control command from a communication network and to output corresponding data, corresponding information or a corresponding control action. An output device may optionally include or be operatively associated with zero or a number of sensors. Non-limiting examples of output devices include ballasts, lights, power relays, relay outputs, water valves, data collection and/or network bridges.

As employed herein, the term “wireless output device” means an apparatus structured to input data, information or a control command from a wireless communication network and to output corresponding data, corresponding information or a corresponding control action.

As employed herein, the term “wired output device” means an apparatus structured to input data, information or a control command from a wired (i.e., non-wireless) input and to output corresponding data, corresponding information or a corresponding control action.

As employed herein, the term “programmable logic controller” (PLC) means a programmable controller, an intelligent relay, a control relay, or another intelligent or microprocessor-based device used for controlling, automating and/or monitoring a residential, commercial or industrial process. Typically, programmable controllers, intelligent relays and control relays are lower-cost, lower-end versions of a PLC. A PLC is usually real-time and can do relatively more complex math. Programmable controllers, intelligent relays and control relays are typically not real time and are typically more restricted in what they can do. For instance, some of the low-end control relays do not include math functions or have memory, while some of the high-end control relays have some math functions and may include counters.

As employed herein, the term “programmable controller” means a microprocessor-based device including a plurality of inputs, a plurality of outputs and a number of programs (e.g., without limitation, ladder diagrams) used for controlling, automating and/or monitoring a residential, commercial or industrial process.

As employed herein, the term “intelligent relay” means a programmable or microprocessor-based device including a plurality of inputs and a plurality of outputs used for controlling, automating and/or monitoring a residential, commercial or industrial process.

As employed herein, the term “control relay” means a programmable or microprocessor-based device including a plurality of inputs and a plurality of outputs used for controlling, automating and/or monitoring a residential, commercial or industrial process.

As employed herein, the term “mains-powered” refers to any node, which has continuous power capabilities (e.g., powered from an AC outlet or AC receptacle or AC power source; AC/DC powered devices; rechargeable battery powered devices; other rechargeable devices), but excluding non-rechargeable battery powered devices.

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; or any suitable processing device or apparatus.

As employed herein, the term “port” means an input and/or output by which a processor or programmable logic controller is connected to another device or apparatus.

As employed herein, the term “expansion port” means a combined input and output by which a programmable logic controller is connected to additional sensors or to additional output devices.

As employed herein, the term “serial port” means a combined input and output by which a programmable logic controller receives serial input information and transmits serial output information.

The invention is described in association with an intelligent relay, although the invention is applicable to a wide range of programmable logic controllers.

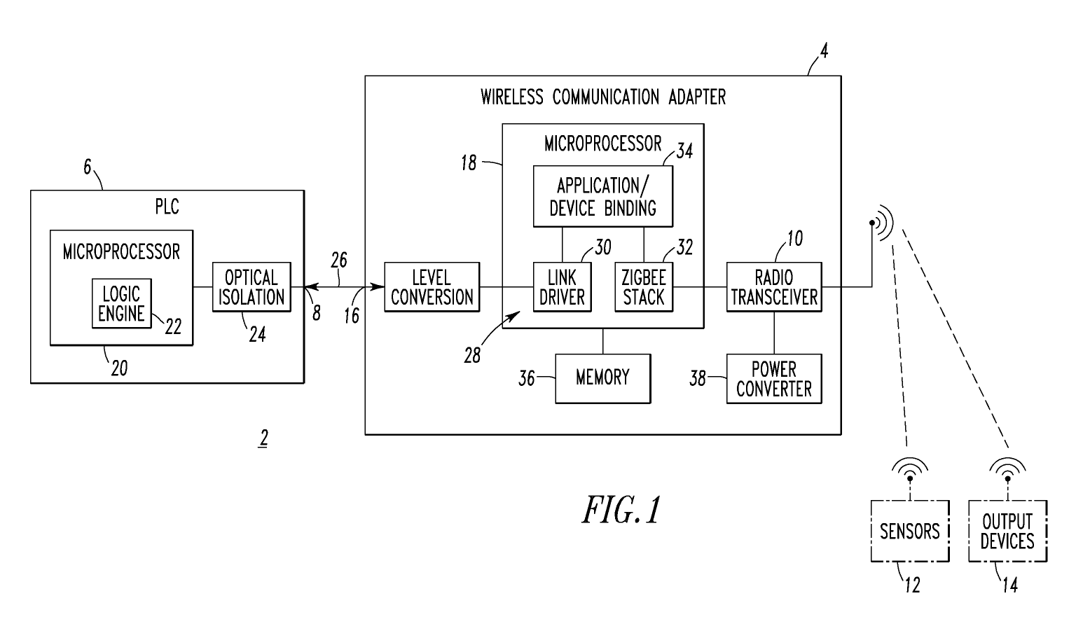

FIG. 1 shows a system 2 including a wireless communication adapter 4 and a programmable logic controller (PLC) 6. The PLC 6 includes a local wired communication port, such as the example expansion port 8. The wireless communication adapter 4 includes a first wireless communication port 10 (e.g., radio transceiver) structured to wirelessly communicate with a number of remote wireless sensors 12 (shown in phantom line drawing) or a number of remote wireless output devices 14 (shown in phantom line drawing), and a second wired communication port 16 structured to communicate with the PLC expansion port 8. The wireless communication adapter 4 also includes a processor 18 (e.g., microprocessor) cooperating with the first wireless communication port 10 and the second wired communication port 16. As will be explained, the processor 18, the first wireless communication port 10 and the second wired communication port 16 are structured to communicate a number of inputs from a number of the remote wireless sensors 12 to the PLC expansion port 8 and/or a number of outputs from the PLC expansion port 8 to a number of the remote wireless output devices 14.

### EXAMPLE 1

The example PLC 6 (e.g., without limitation, an EZ Intelligent Relay marketed by Eaton Electrical, Inc. of Milwaukee, Wis.) includes a microprocessor 20, a logic engine 22, which executes, for example, ladder diagrams, and an expansion port interface 24, which includes, for example and without limitation, optical isolation. The example EZ Intelligent Relay is a programmable switching and control device that is used as a replacement for relay and contactor control circuits. The EZ Intelligent Relay includes logic functions, timer, counter and time switch functions. It is also a control and input device in one that can perform many different tasks. Circuit diagrams are connected up using ladder diagrams, and each element is entered directly via a display (not shown). For example, functions supported by the PLC 6 include: connect make and break contacts in series and in parallel; connect output relays and markers; use outputs as relays, impulse relays or latching relays; use multi-function timing relays with different functions; use up and down counters; count high-speed counter pulses; measure frequencies; process analog inputs; display text with variables, enter setpoints; use year time switches, 7-day time switches; count operating hours; track the flow of current in a circuit diagram; and load, save and password-protect circuit diagrams.

### EXAMPLE 2

The example wireless communication adapter 4 is a wireless expansion module, which complements the PLC 6. The second wired communication port 16 and the PLC expansion port 8 interface a full-duplex, serial link 26, although any suitable wired interface (e.g., without limitation, a parallel bus) may be employed. The processor 18 includes suitable software components 28, namely a link driver 30 for the second wired communication port 16, a wireless protocol (e.g., without limitation, ZigBee™) stack 32 for the first wireless communication port 10, and an application/device binding routine 34 that communicates inputs from the remote wireless sensors 12 to the PLC expansion port 8 and communicates outputs from the PLC expansion port 8 to the remote wireless output devices 14. The wireless communication adapter 4 also includes a memory 36 and a power converter 38. Although a ZigBee™ stack 32 is disclosed, any suitable wireless communication protocol may be employed.

### EXAMPLE 3

Preferably, the link driver 30 supports a suitable parallel communication protocol that supports a suitable count of inputs and outputs with respect to the PLC expansion port 8. As a non-limiting example, 16 discrete inputs and 8 discrete outputs are employed. Alternatively, any suitable count of inputs (e.g., digital; analog; logical) and any suitable count of outputs (e.g., digital; analog; logical) may be employed.

### EXAMPLE 4

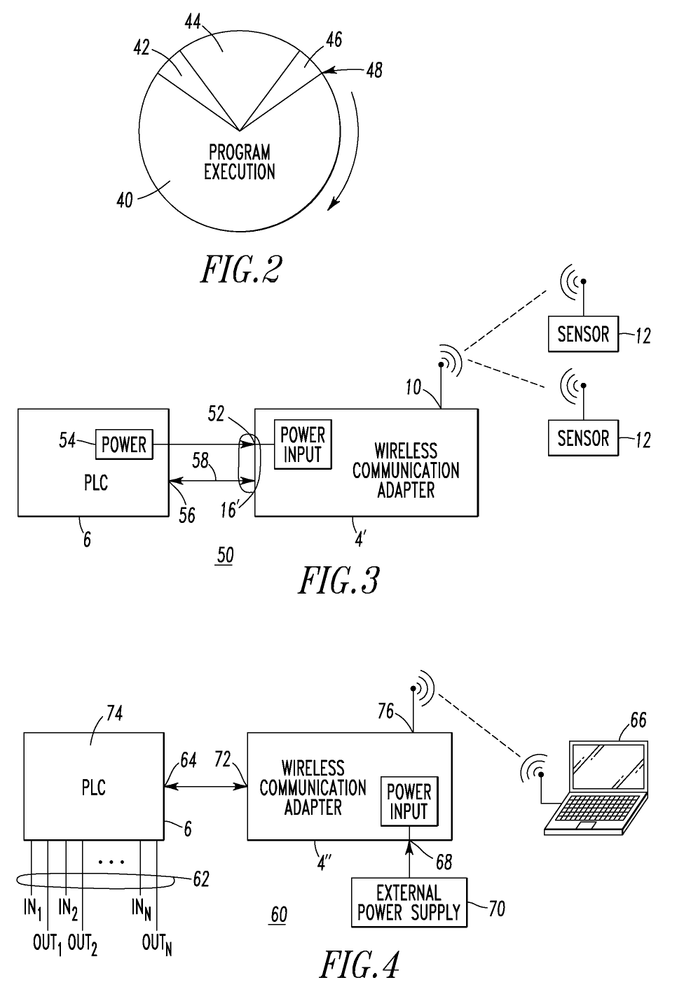

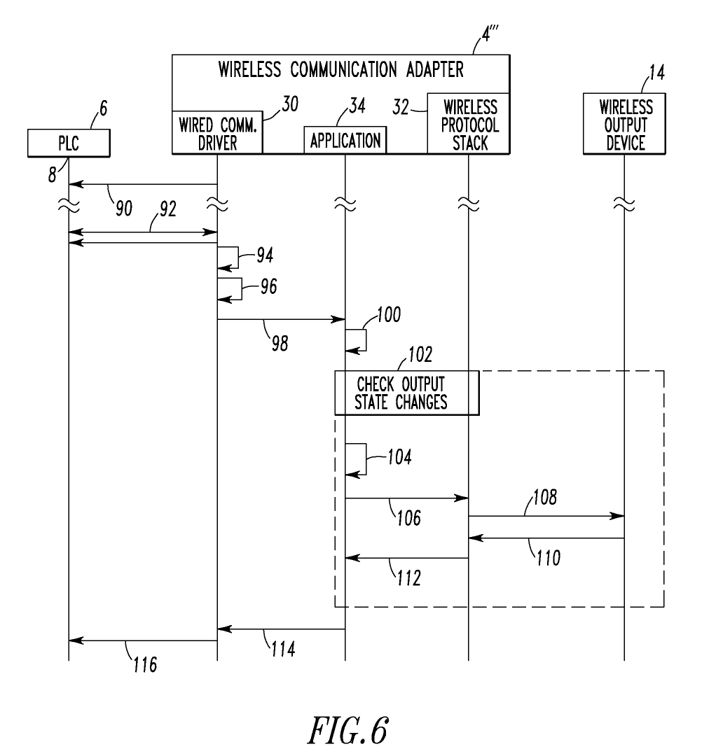

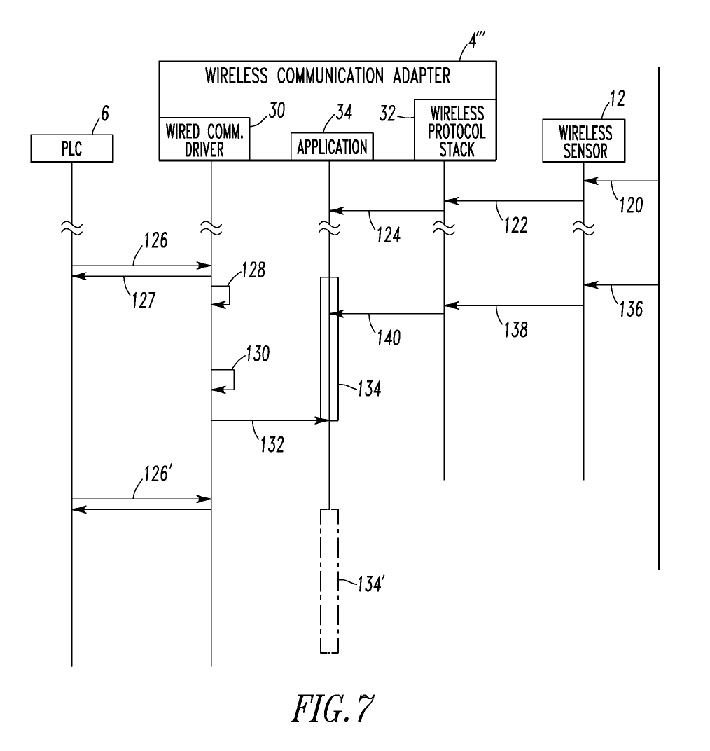

FIG. 2 shows a timing diagram of the operating cycle of the PLC 6 of FIG. 1. This shows the relative timing of program execution 40, writing, at 42, new output states to local PLC outputs (e.g., digital and/or analog) (not shown), other services 44 (e.g., refresh of the PLC display (not shown)), and saving, at 46, the current state of the local PLC inputs (e.g., digital and/or analog) (not shown) in PLC memory (not shown). At 48, the program execution 40 starts. As a non-limiting example, program processing time is about 0.5 mS to about 40 mS. Also, at 48, telegram communication on the link 26 between the second wired communication port 16 and the PLC expansion port 8 begins. As a non-limiting example, the telegram communication time is about 15 mS to about 35 mS. During that time, along with corresponding processing by the wireless communication adapter processor 18, the PLC 6 inputs (FIG. 7) a number of inputs from a number of the remote wireless sensors 12, and outputs (FIG. 6) a number of outputs to a number of the remote wireless output devices 14.

### EXAMPLE 5

FIG. 3 shows another system 50 including the PLC 6 and the wireless sensors 12 of FIG. 1 along with another wireless communication adapter 4′, which is the same as the wireless communication adapter 4 of FIG. 1 except for two differences. First, the wireless communication adapter 4′ includes a power input 52 that is structured to be powered from the power supply 54 of the PLC 6 through a second wired communication port 16′. Second, the second wired communication port 16′ of the wireless communication adapter 4′ is a serial port that is structured to communicate with a serial port 56 of the programmable logic controller 6 over a wired serial link 58. Otherwise, the PLC 6 and the wireless communication adapter 4′ provide the same functions with respect to the wireless sensors 12 as that of the system 2 of FIG. 1. As shown in FIG. 3, the wireless communication adapter 4′ is external to the PLC 6.

### EXAMPLE 6

Although both serial and parallel wired interfaces to the example PLC 6 are disclosed, any suitable wired communication interface may be employed. As non-limiting examples, other suitable communication protocols include INCOM, MODBUS, ProfiBus and DeviceNet. Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein.

### EXAMPLE 7

FIG. 4 shows another system 60 including the PLC 6 of FIG. 1 and another wireless communication adapter 4″. Here, the PLC 6 is structured to communicate a number of inputs from a number of wired input devices or wired output devices 62 to a local wired communication port 64 (e.g., expansion port; serial port). The wireless communication adapter 4″ is the same as the wireless communication adapter 4′ of FIG. 3 except for two or three differences. First, the wireless communication adapter 4″ is structured to communicate the number of inputs or outputs from the PLC local wired communication port 64 to a wirelessly enabled node 66. Second, the wireless communication adapter 4″ includes a power input 68 that is structured to be powered from an external power supply 70. In this example, the second wired communication port 72 of the wireless communication adapter 4″ may be a serial port (as shown by the serial port 16′ of FIG. 3) or a parallel port (as shown by the expansion port 16 of FIG. 1).

### EXAMPLE 8

In addition to the physical inputs or outputs from the wired input devices or wired output devices 62, as is conventional, the PLC 6 also includes state information 74 (e.g., logical states of internal contacts or coils of its ladder diagrams (not shown)). The PLC 6 is structured to output the internal state information 74 to the local wired communication port 64. In addition to the inputs or outputs from the wired input devices or wired output devices 62 of the PLC local wired communication port 64, the wireless communication adapter 4″ is also structured to wirelessly forward the PLC internal state information from the PLC local wired communication port 64 to the wirelessly enabled device 66.

### EXAMPLE 9

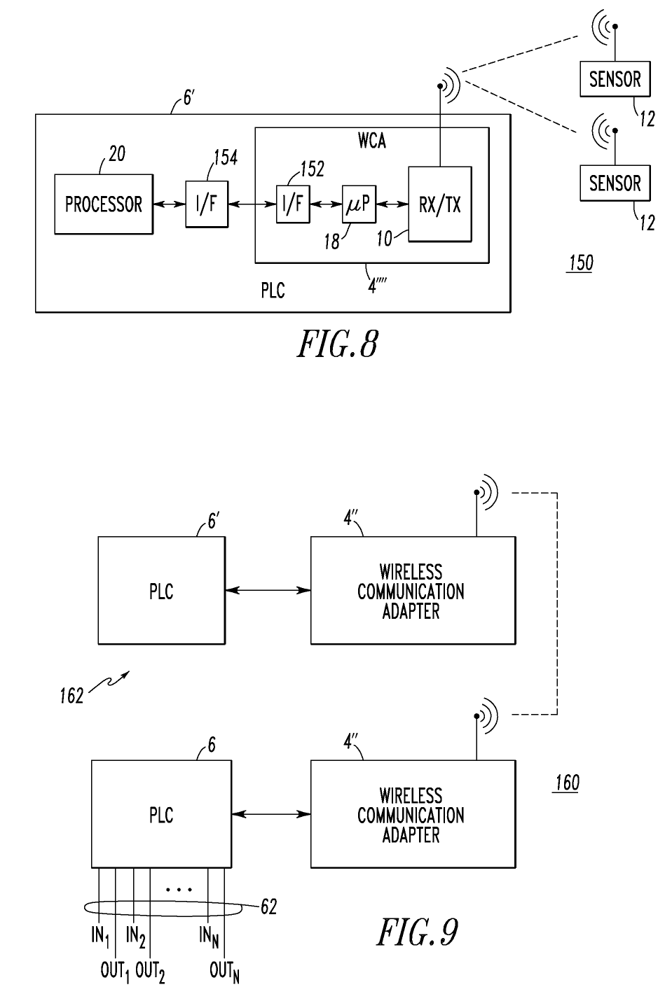

The wirelessly enabled device 66 may be a wirelessly enabled personal computer (PC), as shown in FIG. 4, or may be any other suitable wirelessly enabled device, such as, for example and without limitation, another PLC 6 and another wireless communication adapter 4″ as shown in FIG. 9.

### EXAMPLE 10

The example PC 66 is structured to monitor the inputs or outputs from the wired input devices or wired output devices 62 and/or the internal state information 74, both of which are communicated through the first wireless communication port 76 of the wireless communication adapter 4″.

### EXAMPLE 11

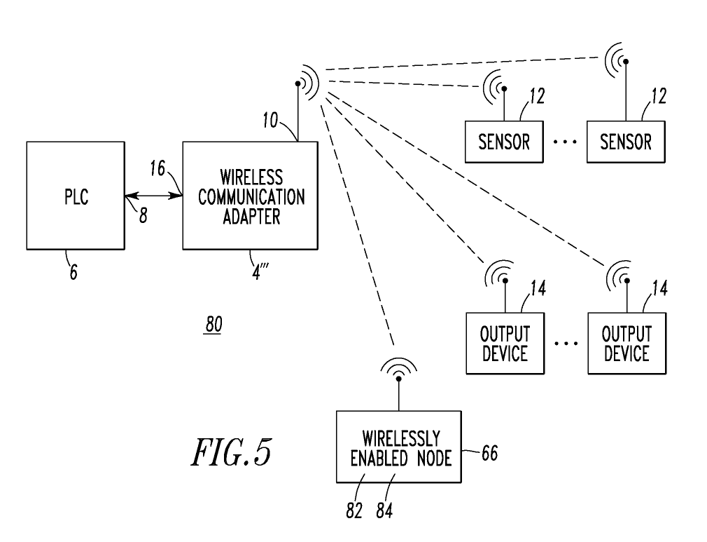

FIG. 5 shows another system 80 including the PLC 6, wireless sensors 12 and wireless output devices 14 of FIG. 1, the wirelessly enabled node 66 of FIG. 4, and another wireless communication adapter 4′″. The wireless communication adapter 4′″ is similar to the wireless communication adapter 4 of FIG. 1 and is structured to communicate a number of inputs from the wireless sensors 12 to the PLC local wired communication port 8, and to communicate a number of outputs from the PLC local wired communication port 8 to the wireless output devices 14. Similar to the wireless communication adapter 4″ of FIG. 4, the wireless communication adapter 4′″ of FIG. 5 is also structured to communicate with the wirelessly enabled node 66.

### EXAMPLE 12

In this example, the wirelessly enabled node 66 is a network coordinator for the various network device nodes 4′″,12,14 and the wireless communication adapter 4′″ is structured to be a router that cooperates with the external network coordinator node 66. For example, information is logically conveyed from the wireless sensors 12 to the network coordinator node 66 and then to the wireless communication adapter 4′″, or from the wireless communication adapter 4′″ to the network coordinator node 66 and then to the wireless output devices 14.

### EXAMPLE 13

In this example, the wireless communication adapter 4′″ is structured to be a network coordinator for the various network device nodes 12,14,66. For example, information is logically conveyed from the wireless sensors 12 to the wireless communication adapter 4′″, or from the wireless communication adapter 4′″ to the wireless output devices 14.

### EXAMPLE 14

In this example, the wireless communication adapter 4′″ is structured to be configured to be one of: (a) a router (as in Example 12) that cooperates with an external network coordinator, such as wirelessly enabled node 66; and (b) a network coordinator (as in Example 13). Here, the wireless communication adapter 4′″ can be configured in either mode depending on the application and what other products are part of the same wireless communication network. For example, the wireless communication adapter 4′″ would be configured to be a router in a pre-existing network in which the wirelessly enabled node 66 is already the network coordinator. As another example, the wireless communication adapter 4′″ would be configured to be a network coordinator in a newly configured network, which may or may not include the wirelessly enabled node 66.

### EXAMPLE 15

Preferably, the wirelessly enabled node 66 of FIG. 5 is a PC including a suitable communication protocol 82 and a programming routine 84 structured to program the PLC 6. Also, the wireless communication adapter 4′″ cooperates with the wirelessly enabled PC 66 and the PLC 6 to program (e.g., the initial program; re-program) the PLC 6.

### EXAMPLE 16

FIG. 6 shows signals, events and messages associated with an output state change of the wireless output device 14 of FIG. 5. Although this is described in connection with the wireless communication adapter 4′″ of FIG. 5, this example is applicable to any of the wireless communication adapters disclosed herein, such as 4 (FIG. 1), 4′ (FIG. 3), 4″ (FIG. 4) or 4″″ (FIG. 8).

After start up of the wireless communication adapter 4′″, at 90, the link driver 30 (FIG. 1) signals the PLC 6 through the PLC expansion port 8 that the adapter 4′″ is ready to receive signals. At about 48 of FIG. 2, the PLC 6 signals, at 92, the link driver 30 through the PLC expansion port 8 to initiate communication. Next, at 94, the link driver 30 captures a number of current input states from the PLC expansion port 8 after which, at 96, the telegram communication from the PLC expansion port 8 is completed. In response, the link driver 30 sets an event flag 98 for the application/device binding routine 34 to indicate that a new telegram was received with a number of output state changes. In response, at 100, the routine 34 processes the new output state changes. Next, a routine 102 that checks output state changes processes one or more output state changes. First, at 104, the corresponding wireless output device 14 is identified. Next, the routine 34 generates a message 106 for the wireless protocol stack 32 in order to initiate the state changes. In response, the stack 32 sends an output state change message 108 to the corresponding wireless output device 14. In response, the corresponding wireless output device 14 changes its output state and confirms receipt of the message 108 with an acknowledge message 110 sent back to the stack 32. Next, the stack 32 generates an acknowledgement 112 that the output state change message has been transmitted successfully for the routine 34 to indicate that the output state has been changed. The routine 102 repeats the actions corresponding to 104,106,108,110,112 for any additional output state changes associated with the event flag 98. If all of the state change transactions are completed, then the routine 34 sets an event flag 114 for the link driver 30 in order to confirm that all state change transactions are completed. Finally, at 116, similar to 90, the link driver 30 signals the PLC 6 through the PLC expansion port 8 that the adapter 4′″ is again ready to receive signals. The process is repeated again at about 48 of FIG. 2, when the PLC 6 signals, at 92, the link driver 30 through the PLC expansion port 8 to re-initiate communication. Alternatively, the PLC 6 may start communication through the PLC expansion port 8 at 48 when the wireless communication adapter 4′″ is ready to receive messages.

### EXAMPLE 17

FIG. 7 shows signals, events and messages associated with an input state change of the wireless sensor 12 of FIG. 5. Although this is described in connection with the wireless communication adapter 4′″ of FIG. 5, this example is applicable to any of the wireless communication adapters disclosed herein, such as 4 (FIG. 1), 4′ (FIG. 3), 4″ (FIG. 4) or 4″″ (FIG. 8).

First, at 120, the wireless sensor 12 receives an event (e.g., without limitation, pushbutton closed; pushbutton opened; temperature limited exceeded) associated with its physical input (not shown). In response, the wireless sensor 12 sends an input state change message 122 to the wireless protocol stack 32. Then, the stack 32 responsively sets an event flag 124 for the application/device binding routine 34.

At about 48 of FIG. 2, the PLC 6 signals, at 126, the link driver 30 through the PLC expansion port 8 to initiate communication. At signal 127, the link driver 30 communicates input state changes back to the PLC 6. Next, at 128, the link driver 30 captures a number of current input states (including the state associated with the input state change message 122) after which, at 130, the telegram communication to the PLC expansion port 8 is completed. In response, the link driver 30 sets an event flag 132 for the routine 34 to indicate that a new telegram was received for a number of output state changes. Step 128 and event flag 132 define a time period 134. Any input state changes that are received during this time period 134 are not communicated to the PLC 6 until the next telegram, which occurs responsive to the next periodic signal 126′ from the PLC 6.

Hence, at 136, the wireless sensor 12 may receive another event associated with its physical input and, thus, would send another input state change message 138 to the wireless protocol stack 32, which responsively sets another event flag 140 for the routine 34. This input state change is communicated to the PLC 6 in response to the next telegram, which occurs in the next time period 134′ responsive to the next periodic signal 126′ from the PLC 6.

### EXAMPLE 18

In this example, the input and output binding of the application/device binding routine 34 is hard coded in that application. Here, the routine 34 is preconfigured to communicate a predetermined number of inputs from the wireless sensors 12 to the local PLC expansion port 8, and a predetermined number of outputs from the local PLC expansion port 8 to the wireless output devices 14. A particular wireless sensor 12 (e.g., SENSOR 1) is directly associated with a predetermined logical variable (e.g., R1) of the PLC 6, and a particular wireless output device 14 (e.g., OUTPUT 2) is directly associated with a predetermined logical variable (e.g., S2) of the PLC 6.

### EXAMPLE 19

In this example, the input and output binding of the application/device binding routine 34 is configurable through a suitable user commissioning process. The routine 34 is structured to be configured to communicate a plurality of inputs from the wireless sensors 12 to the local PLC expansion port 8, and a plurality of outputs from the local PLC expansion port 8 to the wireless output devices 14. A particular wireless sensor 12 (e.g., SENSOR 3) may be configured to be associated with any logical variable (e.g., R12) of the PLC 6, and a particular wireless output device 14 (e.g., OUTPUT 4) may be configured to be associated with any logical variable (e.g., S3) of the PLC 6.

### EXAMPLE 20

FIG. 8 shows another system 150 including a PLC 6′ and the wireless sensors 12 of FIG. 1. The PLC 6′ is similar to the combined PLC 6 and wireless communication adapter 4 of FIG. 1, except that the wireless communication adapter 4″″ of FIG. 8 is internal to the PLC 6′. As a result, the internal wireless communication adapter 4″″ includes a second wired communication port 152 structured to communicate with an internal wired communication port 154 of the PLC processor 20.

### EXAMPLE 21

FIG. 9 shows a system 160 including the PLC 6 and wireless communication adapter 4″ of FIG. 4, along with another PLC 6 and another wireless communication adapter 4″, which form a wirelessly enabled node 162. The wireless communication adapter 4″ of FIG. 4 is structured to input a number of inputs or outputs from a number of the wired PLC input devices or wired PLC output devices 62 and forward the same to the node 162.

### EXAMPLE 22

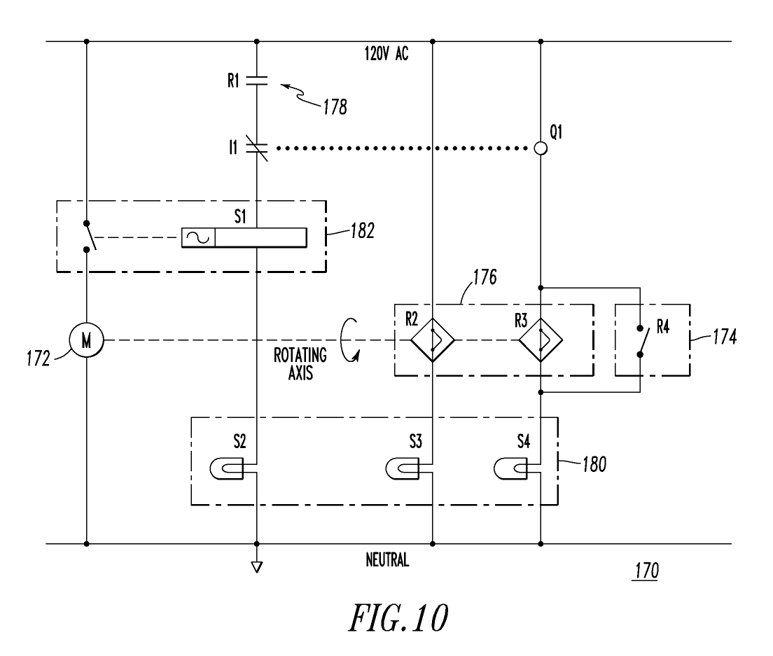

FIG. 10 shows an example ladder diagram 170, which may be executed by the PLC 6 of FIG. 5 as part of the system 80, which includes plural wireless sensors 12 and plural wireless output devices 14. The system 80 is operatively associated with the control and monitoring of a motor (M) 172 (not shown, but represented in the ladder diagram 170). In this example, the various wireless sensors 12 are represented in the ladder diagram 170 by a wireless temperature sensor 174 (the normally open contact (R4) thereof being closed when a predetermined temperature limit is sensed), a wireless proximity sensor switch/pulse counter 176 (including contacts R2 and R3), as will be described, and a wireless pushbutton 178 (including normally open contact R1, which is closed when a pushbutton (not shown) is pressed). For example, the proximity sensor switch/pulse counter 176 may be an iProx (intelligent inductive proximity) sensor marketed by Eaton Electrical, Inc. of Milwaukee, Wis. This type of sensor can be reprogrammed in a SpeedSense mode. In this mode, the proximity sensor counts pulses and determines rotating speed. If the sensor determines the speed to be above a preconfigured value, then it turns the output on. Alternatively, if the speed is below the preconfigured value, then it turns the output off. Also, in this example, the various wireless output devices 14 are represented in the ladder diagram 170 by a wireless light indicator (e.g., stack light) 180 (including indicators S2, S3 and S4) and a wireless starter 182 (including output S1), as both will be described.

A wireless trip unit (not shown) provides power to the PLC 6 (FIG. 5), which, in turn, controls the motor (M) 172 through the wireless starter 182. The wireless temperature sensor 174 monitors the motor's temperature and outputs a signal corresponding to normally open contact R4 when a predetermined temperature limit is reached. The wireless proximity switch/pulse counter 176 monitors the motor's speed, outputs a first signal corresponding to contact R2 when the pulse count is between 60% and 80% of a predetermined maximum pulse count, and outputs a second signal corresponding to contact R3 when the pulse count is below 60% of the predetermined maximum pulse count. The proximity sensor switch/pulse counter 176 determines the speed by measuring the time between pulses and the “speed” threshold is programmed as a duration of time (i.e., the time between pulses). When either of the contacts R3 or R4 are closed, the red stack light (S4) is illuminated, internal logical relay coil (Q1) is activated and internal logical normally closed contact (I1) is opened to cause the wireless starter 182 (S1) to remove power from the motor 172 (M). When the contact (R2) is closed, the yellow stack light (S3) is illuminated. When contact (R1) is activated by the wireless pushbutton 178 and the normally closed contact (I1) is closed, this causes the wireless starter 182 (S1) to apply power to the motor (M) and to illuminate the green stack light (S2). The example wireless stack light 180 includes three different colored indicators and is employed to show if the present motor speed is within a specified range. The motor is stopped or started by the wireless pushbutton 178. A wireless commissioning tool (not shown) as part of the node 66 of FIG. 5 may also be employed to commission and monitor the state of the system 80. For example, the node 66 may be a PC that displays the states of all of the wirelessly enabled devices, such as the trip unit information, various input/output states of the wireless nodes 12,14, and the current temperature.

In the example ladder diagram 170, the various “S” outputs (S1-S4) are remote outputs that are wirelessly communicated from the PLC 6 and through the wireless communication adapter 4″ to the remote wireless output devices 14. The various “R” inputs (R1-R4) are remote inputs that are wirelessly communicated from wireless sensors 12 through the wireless communication adapter 4″ to the PLC 6. The example ladder diagram 170 also includes local PLC inputs (e.g., I1) and local PLC outputs (e.g., Q1). These local PLC inputs and outputs may, but need not be, associated with conventional wired PLC inputs or wired PLC outputs (e.g., 62 of FIG. 4).

### EXAMPLE 23

In addition to the example wireless stack light 180, wireless trip unit (not shown) and wireless starter 182, any suitable wireless output device may be employed. For example and without limitation, the wireless communication adaptor 4″ can easily interface to any other suitable wirelessly enabled output device.

### EXAMPLE 24

The two communication protocols of the stack 32 and the link driver 30 may operate independent of one another and may not be synchronized.

### EXAMPLE 25

In this example, the wireless communication adapter 4′″ of FIG. 5 is structured to be an end device (i.e., a “wireless output device”). Here, the wireless communication adapter 4′″ is structured to request any pending incoming messages (sent by any of the wireless sensors 12) from its network coordinator (e.g., wirelessly enabled node 66).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A wireless communication adapter for a programmable logic controller including a local wired communication port, said wireless communication adapter comprising:
a first wireless communication port structured to wirelessly communicate with a number of remote wireless sensors or a number of remote wireless output devices;
a second wired communication port structured to communicate with the local wired communication port of said programmable logic controller; and
a processor cooperating with said first wireless communication port and said second wired communication port,
wherein said processor, said first wireless communication port and said second wired communication port are structured to communicate a number of inputs from said number of remote wireless sensors to the local wired communication port of said programmable logic controller or a number of outputs from the local wired communication port of said programmable logic controller to said number of remote wireless output devices.

2. The wireless communication adapter of claim 1 wherein the local wired communication port of said programmable logic controller is an expansion port; and wherein said second wired communication port is structured to communicate with the expansion port of said programmable logic controller.

3. The wireless communication adapter of claim 1 wherein the local wired communication port of said programmable logic controller is a serial port; and wherein said second wired communication port is structured to communicate with the serial port of said programmable logic controller.

4. A system comprising:
a programmable logic controller comprising a local wired communication port;
a number of wireless sensors;
a wireless communication adapter comprising:
a first wireless communication port structured to wirelessly communicate with said number of wireless sensors,
a second wired communication port structured to communicate with the local wired communication port of said programmable logic controller, and
a processor cooperating with said first wireless communication port and said second wired communication port,
wherein said processor, said first wireless communication port and said second wired communication port are structured to communicate a number of inputs from said number of wireless sensors to the local wired communication port of said programmable logic controller.

5. The system of claim 4 wherein said wireless communication adapter is external to said programmable logic controller.

6. The system of claim 4 wherein said programmable logic controller further comprises a power supply; and wherein said wireless communication adapter is structured to be powered from said power supply through said second wired communication port.

7. The system of claim 4 wherein said wireless communication adapter further comprises a power input and wherein said power input is structured to be powered from an external power supply.

8. The system of claim 4 wherein said wireless communication adapter is internal to said programmable logic controller.

9. A system comprising:
a wirelessly enabled node;
a programmable logic controller comprising:
a local wired communication port, and
a number of wired input devices or wired output devices;
a wireless communication adapter comprising:
a first wireless communication port structured to wirelessly communicate with said wirelessly enabled node,
a second wired communication port structured to communicate with the local wired communication port of said programmable logic controller, and
a processor cooperating with said first wireless communication port and said second wired communication port,
wherein said programmable logic controller is structured to communicate a number of inputs or outputs from said number of wired input devices or wired output devices to said local wired communication port, and
wherein said processor, said second wired communication port and said first wireless communication port are structured to communicate said number of inputs or outputs from the local wired communication port of said programmable logic controller to said wirelessly enabled node.

10. The system of claim 9 wherein said programmable logic controller is further structured to output internal state information to said local wired communication port; and wherein said processor, said second wired communication port and said first wireless communication port are further structured to communicate said internal state information from the local wired communication port of said programmable logic controller to said wirelessly enabled node.

11. The system of claim 9 wherein said wirelessly enabled node is a wirelessly enabled personal computer, which is structured to monitor said number of inputs or outputs as communicated through said first wireless communication port.

12. The system of claim 11 wherein said wirelessly enabled personal computer comprises a programming routine structured to program said programmable logic controller; and wherein said wireless communication adapter cooperates with said wirelessly enabled personal computer and said programmable logic controller to program said programmable logic controller.

13. The system of claim 9 wherein said wirelessly enabled node comprises another programmable logic controller and another wireless communication adapter; and wherein said another wireless communication adapter is structured to input or output said number of inputs or outputs as communicated through said first wireless communication port and forward the same to said another programmable logic controller.

14. A system comprising:
a programmable logic controller comprising a local wired communication port;
a number of wireless sensors;
a number of wireless output devices;
a wireless communication adapter comprising:
a first wireless communication port structured to wirelessly communicate with said number of wireless sensors,
a second wired communication port structured to communicate with the local wired communication port of said programmable logic controller, and
a processor cooperating with said first wireless communication port and said second wired communication port,
wherein said processor, said first wireless communication port and said second wired communication port are structured to communicate a number of inputs from said number of wireless sensors to the local wired communication port of said programmable logic controller, and
wherein said processor, said second wired communication port and said first wireless communication port are further structured to communicate a number of outputs from the local wired communication port of said programmable logic controller to said number of wireless output devices.

15. The system of claim 14 wherein said processor comprises a routine that is preconfigured to communicate said number of inputs from said number of wireless sensors to the local wired communication port of said programmable logic controller, and said number of outputs from the local wired communication port of said programmable logic controller to said number of wireless output devices.

16. The system of claim 14 wherein said number of wireless sensors is a plurality of wireless sensors; wherein said number of wireless output devices is a plurality of wireless output devices; wherein said processor comprises a routine that is structured to be configured to communicate a plurality of inputs from said wireless sensors to the local wired communication port of said programmable logic controller, and a plurality of outputs from the local wired communication port of said programmable logic controller to said wireless output devices.

17. The system of claim 14 wherein said wireless communication adapter is structured to be a router that cooperates with an external network coordinator.

18. The system of claim 14 wherein said wireless communication adapter is structured to be a network coordinator.

19. The system of claim 14 wherein said wireless communication adapter is structured to be configured to be one of: (a) a router that cooperates with an external network coordinator; and (b) a network coordinator.

20. The system of claim 14 wherein said wireless communication adapter is structured to be an end device.
